(19) United States
(12) Patent Application Publication
(10) Pub. No.: US 2005/0018298 A1
(43) Pub. Date: Jan. 27, 2005

(54) Method and apparatus for generating terahertz radiation

(76) Inventors: Seth Trotz, Littleton, MA (US); David A. New, Mercerville, NJ (US); Alan M. Braun, Lawrenceville, NJ (US)

Correspondence Address: MOSER, PATTERSON & SHERIDAN, LLP;/SARNOFF CORPORATION, 595 SHREWSBURY AVENUE, SUITE 100, SHREWSBURY, NJ, 07702, US

(21) Appl. No.: 10/845,821

(22) Filed: May 14, 2004

Related U.S. Application Data
(60) Provisional application No. 60/471,381, filed on May 16, 2003.
(60) Provisional application No. 60/530,508, filed on Dec. 18, 2003.

(51) Int. Cl. G02B 6/04; G02B 5/18; G02B 27/44

(52) U.S. Cl. 359/575; 359/566

(57) ABSTRACT

The invention is a method and apparatus for generating terahertz radiation. The terahertz source is a versatile terahertz device that can be configured to transmit a plurality of wavelengths, thereby facilitating the detection of multiple contaminants using a single source device. In one embodiment, the Smith-Purcell radiation effect is exploited by passing an electron beam over a modulated conducting surface, wherein the spacing of the periods of the modulated surface is varied. The variations in the modulated surface enable the source to produce light of varying wavelengths.

### CROSS REFERENCE TO RELATED APPLICATIONS

This application claims the benefit of U.S. Provisional Patent Application Ser. No. 60/471,381, filed May 16, 2003 (titled “Terahertz Source and Applications”), and of U.S. Provisional Patent Application No. 60/530,508, filed Dec. 18, 2003 (titled “An Autonomous Rapid Facility Chemical Agent Monitor Via Smith-Purcell Terahertz Spectrometry”), both of which are herein incorporated by reference in their entireties.

### FIELD OF THE INVENTION

The present invention generally relates to the detection of chemical and biological contaminants, and more particularly relates to the generation of terahertz radiation to detect contaminants.

### BACKGROUND OF THE INVENTION

There is an increasing demand for systems for military, private or individual use that are capable of detecting and analyzing chemical and biological contaminants, such as explosives (e.g., TNT or DNT). One method of detecting such contaminants uses rotational microwave spectroscopy. The rotational and vibrational modes of molecules (e.g., contaminant molecules) have energies that naturally correspond to energies of photons in a spectrum of radiation. A source generates radiation that interacts with contaminant molecules present in a “target” to be analyzed, so that specific frequencies of emitted light are absorbed by the molecules. A detector is positioned to identify the frequencies that fail to transmit through the target, and the failure of a particular frequency to transmit can indicate the presence of a specific absorbing contaminant.

The far infrared (or terahertz) spectrum of radiation is particularly well-suited for use in systems such as that described above, because the spectrum corresponds to the vibrational and rotational modes of many chemicals, including explosives, and contains a great deal of signature information. Unfortunately, the effectiveness of conventional terahertz source devices is limited because the devices tend to be fixed such that they can only be used to transmit a very narrow range of frequencies of radiation. This can lead to confusing or incomplete results, because contaminants may often be capable of absorbing a number of frequencies. Thus, the lack of a sufficient spectrum of radiation for analysis purposes may cause some contaminants to be overlooked or misidentified. Generation of a sufficient spectrum of frequencies can therefore require several devices, and this limitation can make the use of terahertz sources complicated and costly.

Therefore, there is a need in the art for a terahertz source that can produce a spectrum of terahertz radiation for use in the detection of contaminants.

### SUMMARY OF THE INVENTION

The invention is a method and apparatus for a terahertz source. The terahertz source is a versatile terahertz device that can be configured to transmit a plurality of wavelengths, thereby facilitating efficient detection of contaminants in a target using a single source device. In one embodiment, the Smith-Purcell radiation effect is exploited by passing an electron beam over a modulated conducting surface, wherein the spacing of the periods of the modulated surface is varied. The variations in the modulated surface enable the source to produce light of varying wavelengths. In another embodiment, a method for generating terahertz radiation using a mode-locked semiconductor laser is provided.

### BRIEF DESCRIPTION OF THE DRAWINGS

So that the manner in which the above recited embodiments of the invention are attained and can be understood in detail, a more particular description of the invention, briefly summarized above, may be had by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a perspective view of a modulated conducting surface that may be used to produce Smith-Purcell radiation;

FIG. 2 illustrates a plan view of a variable-period modulated conducting surface according to the present invention, in which the period is “deformed”;

FIG. 3 illustrates a perspective view of the modulated conducting surface of FIG. 2, wherein the modulated conducting surface is mounted on a rotatable cylinder;

FIG. 4 illustrates top schematic view of a variable-period modulated conducting surface according to the present invention, in which the conducting surface comprises at least two sections having different periods;

FIG. 5 illustrates a top view of a variable-period modulated conducting surface according to the present invention, in which the conducting surface is tapered; and

FIG. 6 illustrates a flow diagram of a method for generating terahertz radiation using a mode-locked semiconductor laser.

To facilitate understanding, identical reference numerals have been used, where possible, to designate identical elements that are common to the figures.

### DETAILED DESCRIPTION

A method and apparatus are provided for generating a spectrum of terahertz radiation. The terahertz source is a continuously tunable electromagnetic wave device that, in several embodiments, exploits the phenomena of Smith-Purcell radiation to produce multiple wavelengths of light. In one embodiment, the Smith Purcell radiation produced is in the far infrared region of the spectrum.

Smith-Purcell radiation is produced when an electron beam is passed in a vacuum close to the surface of a periodically modulated conducting surface (e.g., a “grating”). The grating essentially “bunches” the beam and causes the beam to radiate. This produces light having a wavelength that is a function of the periodicity of the grating, the velocity of the electrons, and the angle at which the light is observed relative to the direction of the electron beam. At low voltages, light is typically emitted at an angle normal to the grating.

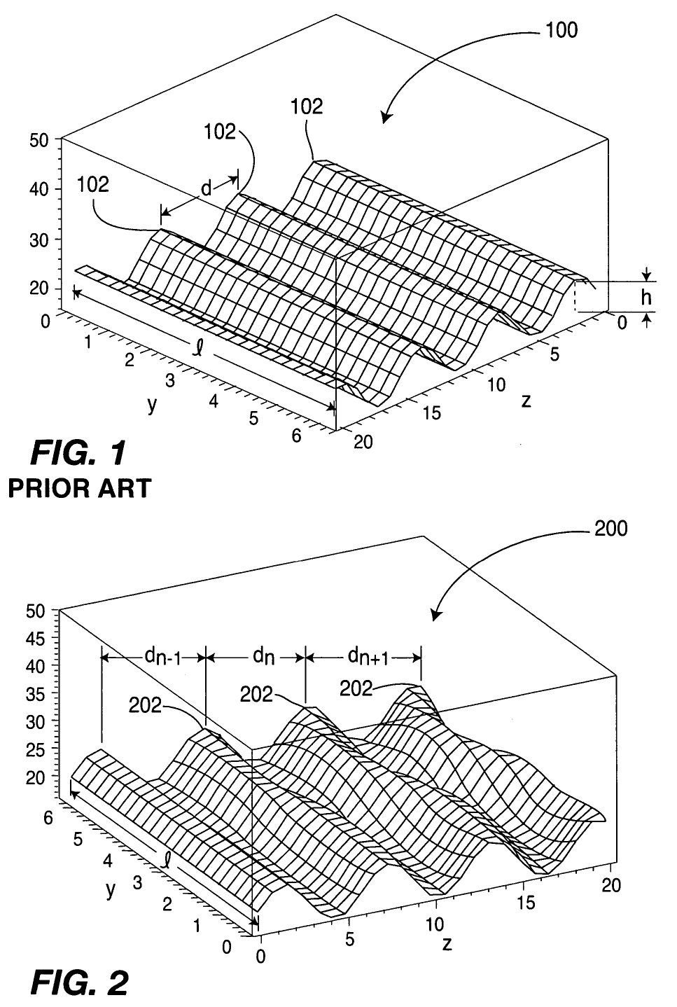

FIG. 1 illustrates a perspective view of a conventional sinusoidal grating 100 that may be used to produce Smith-Purcell radiation. The conventional grating 100 is static—that is, the periodicity is constant, as is evidenced by the peaks 102 that are each spaced a substantially equal distance d from the next peak 102. The distance d is substantially constant over the entire length l of adjacent peaks 102. Furthermore, the peaks 102 are all of substantially equal height h, and the height h is substantially constant along the entire length l of the peaks 102. Thus, for example, an electron traveling from (z, y)=(0, 3) to (z, y)=(20, 3) along the z axis will encounter substantially the same conditions as an electron traveling from (z, y)=(0, 2) to (z, y)=(20, 2). Therefore, as long as the velocity of a group of electrons passing over the grating 100 remains constant, light having a single, substantially constant wavelength (as observed along a given viewing angle) will be produced.

FIG. 2 illustrates a plan view of one embodiment of a grating 200 that may be advantageously adapted for use with the present invention. The periodicity of the grating 200 is varied in the y direction to create a “deformed” period. That is, a periodic variation is created in the heights of the peaks 202 along their lengths l and in the distances dₙ₋₁, dₙ, dₙ₊₁, etc. between the peaks 202. Thus, for example, an electron traveling from (z, y)=(0, 3) to (z, y)=(20, 3) along the z axis will not necessarily encounter the same conditions (i.e., the same period of grating) as an electron traveling from (z, y)=(0, 2) to (z, y)=(20, 2). Therefore, the varying periodicity of the grating 200 allows a source into which it is integrated to produce light having multiple (or “swept”) wavelengths. This is desirable because swept wavelength outputs can be used to perform spectroscopic identification (i.e., by measuring the differential absorption of a target).

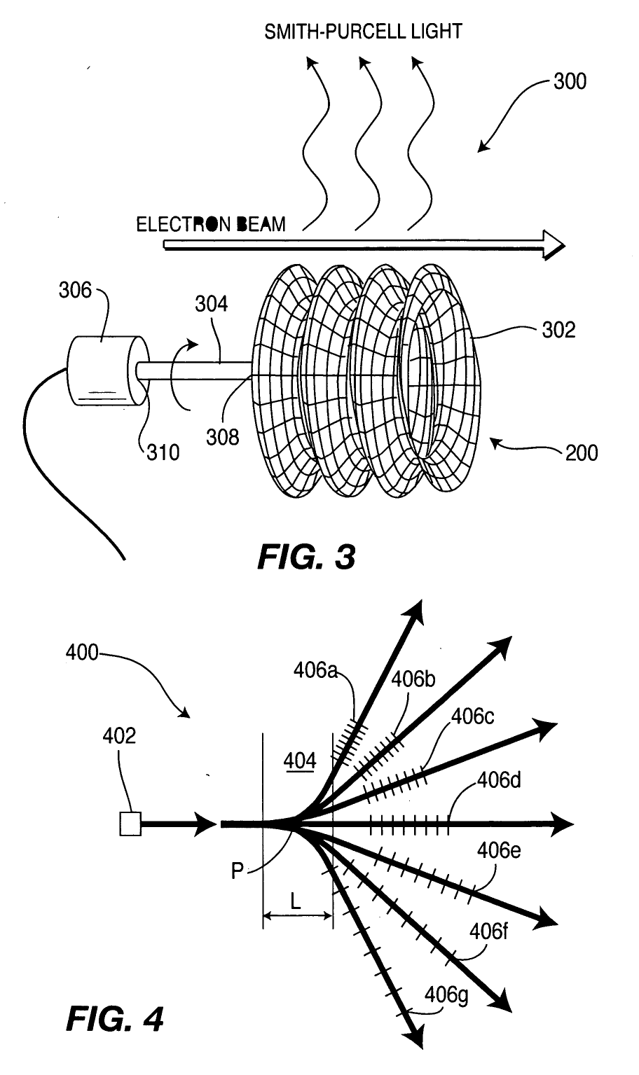

FIG. 3 illustrates a perspective view of one embodiment of a tunable terahertz source device 300 in which the periodically varied grating 200 illustrated in FIG. 2 may be used to advantage. The device 300 comprises a modulated cylinder 302, a drive shaft 304, and a motor 306. The modulated cylinder comprises the periodically varied grating 200 illustrated in FIG. 2, mounted to and wrapped around a first end 308 of the drive shaft 304. The motor 306 is coupled to an opposite second end 310.of the drive shaft 304. Although the periodically varied grating 200 is mounted on a cylinder 302, rotatable surfaces having other shapes may also be used to advantage. In use, the motor 306 slowly rotates the drive shaft 304 and cylinder 302 so that when an electron beam passes closely to the rotating cylinder 302, the electron beam encounters a grating 200 whose periodicity varies with the rotation of the cylinder 302. As the electron beam passes over the periodically varying grating 200, the Smith-Purcell light that is produced will vary periodically and continuously in time. Thus, the light generated by the device 300 may be “tuned” to produce various wavelengths of light, while the velocity of the electrons passing over the device 300 remains substantially constant.

FIG. 4 is a schematic diagram illustrating a second embodiment of a tunable terahertz source device 400 according to the present invention. The device 400 comprises an electron beam source 402, a deflection yoke 404 and at least two sets of substantially uniform-period gratings 406a-g (hereinafter collectively referred to as “gratings 406”). Although the embodiment illustrated in FIG. 4 depicts seven sets of gratings 406, any number of gratings 406 numbering two or more may be used. In one embodiment, the gratings 406 radiate outward from a common starting point P at various angles, and the periodicity of each grating 406 is different (e.g., in the embodiment illustrated in FIG. 4, the “peaks” of grating 406a are spaced closely together, while the peaks of grating 406g are spaced further apart). The yoke 404 is positioned between the electron beam source 402 and the starting point P of the gratings 406. The deflection yoke 404 has at least one aperture (not shown), and the deflection yoke 404 is movable so that the aperture may be positioned along the axis of any one of the gratings 406.

Thus, when an electron beam is emitted by the electron beam source 402, it is received by the deflection yoke 404, and the beam is deflected along a chosen grating 406 (depending on how the deflection yoke 404 is positioned). Thus terahertz source device 400 is tunable to produce electromagnetic radiation in a broad spectrum. In one embodiment, the device 400 produces tunable electromagnetic radiation in the ten micron to one millimeter range of the electromagnetic spectrum.

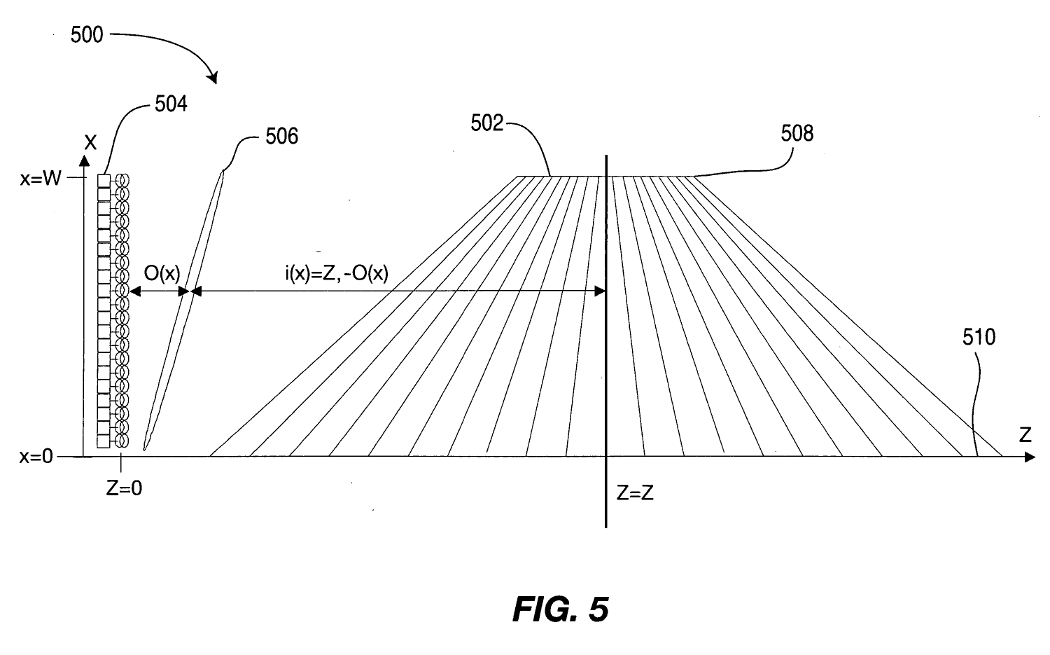

FIG. 5 is a top view of a third embodiment of a terahertz source device 500 according to the present invention. The device 500 comprises a grating 502 and an array of emitters 504. The grating 502 is tapered so that the periodicity of the grating 502 gradually increases from a first end 508 of the grating 502 to a second end 510 of the grating 502. The array of emitters 504 is configured laterally, so that the emitters form a line that is substantially coplanar with the grating 502. The array of emitters 504 emits several small electron beams (not shown) that pass closely to the grating 502 in the form of a sheet. In one embodiment, all beams emitted from the array of emitters 504 are emitted at the same voltage. When the electron beams simultaneously encounter the grating 502 having a varying periodicity, each beam radiates at a different frequency so that the device 500 produces a polychromatic spectrum (i.e., the device 500 has output at substantially all frequencies simultaneously).

In one embodiment, the device 500 includes an optional lens 506 positioned between the array of emitters 504 and the grating 502. Each individual electron beam produced by the emitters requires a different focusing parameter depending on the periodicity of the grating that it encounters (e.g., a more rapid focus is needed for a beam traveling over a short period than for a beam traveling over a longer period). The lens 506 focuses the electron beams produced by the emitters so that the beams are maintained in close proximity to the grating 502. The lens 506 has varying optical properties (e.g., focal length) over its surface, and in one embodiment, the lens 506 is an electrostatic or magnetic lens. Therefore, as the electron beams pass through the lens 506, each beam encounters a different strength lens. Therefore, the lens 506 provides the correct focusing to maintain close proximity between the electron beams and the grating 502 for all periods of the grating 502, so that maximum output from the device 500 is obtained.

As illustrated in FIG. 5, the lens 506 is angled to provide the correct focusing for each electron beam passing therethrough. To achieve proper focusing for all beams emitted by the array of emitters 504, the waists for all beams must be at the same z location. The focal length f(x) necessary to properly focus a particular beam is dependent upon the distance from the emitter at which the beam originates to the lens 506, or o(x), and upon the distance from the lens 506 to the image produced by the beam, or i(x). The proper focal length f(x) may be computed as

$$- \frac{M ( x ) {z}_{f}}{( 1 - M ( x ) ) 2} ,$$

wherein
M(x) is demagnification and is defined as

$$- \frac{i ( x )}{o ( x )}$$

and z_{f} is the z location of the waists of each electron beam. M(x) is always less than zero, so f(x) will always be a positive value.

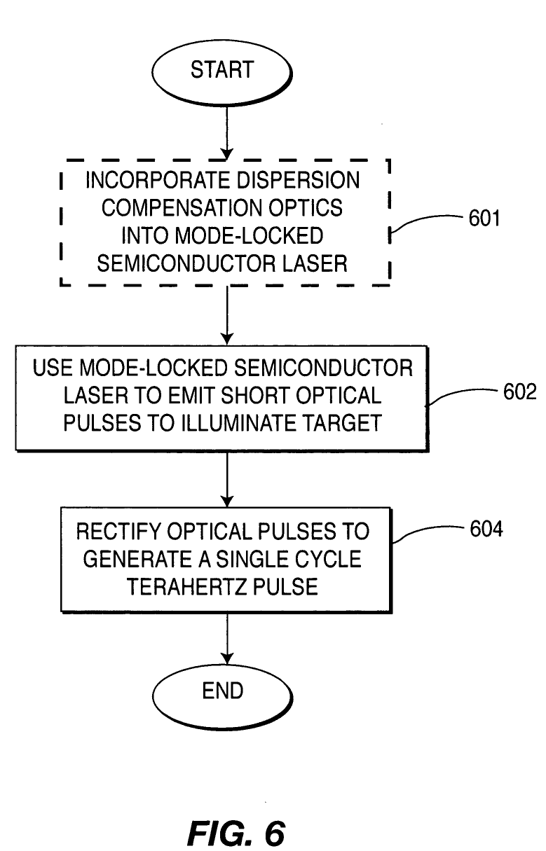

FIG. 6 is a flow diagram illustrating one method for a fourth embodiment of the present invention, in which multiple wavelengths in the far infrared spectrum are produced by a mode-locked semiconductor laser. Mode-locked semiconductor lasers are chip-based lasers that produce ultra-short optical pulses. The pulses are sufficiently energetic to produce terahertz emissions when the pulses are incident on a target (e.g., an absorbing semiconductor). In general, there are two mechanisms by which these optical pulses can produce a broadband, single cycle terahertz pulse: photoconductive generation of transient current and optical rectification via instantaneous nonlinearity.

The first mechanism utilizes application of a photoconductive switch (e.g., fabricated on GaAS or silicon substrates), where the generated THz waveform is proportional to the time-derivative of the generated photocurrent. The second mechanism produces a waveform proportional to the second-derivative of the laser pulse. For optical rectification, phase-matched non-linear material (e.g., ZnTe or DAST, among others) is needed for the generation of THz emission. The ultrashort optical drive pulse generates a THz pulse with a broadband spectrum extending from near DC to a value proportional to the inverse of the optical pulse duration (THz range).

One example of a mode-locked semiconductor laser that may be used to advantage with the method illustrated in FIG. 6 is an external cavity semiconductor laser such as that disclosed by Gee et al. (“High-Power Mode-Locked External Cavity Semiconductor Laser Using Inverse Bow-Tie Semiconductor Optical Amplifiers”, IEEE Journal of Selected Topics in Quantum Electronics, Vol. 4, No. 2, March/April 1998).

As illustrated in FIG. 6, a short optical pulse is emitted from a mode-locked semiconductor laser in step 602 to illuminate a target. At step 604, the pulse reaches the target, and, depending on target geometry, generates a single-cycle THz pulse (e.g., broadband emission extending into the THz range). To achieve high frequency terahertz radiation, the shortest possible pulses are emitted from the laser source at step 602. The highest achievable frequency is given approximately by the inverse of the optical pulse duration. In one embodiment, compensation optics, such as grating, prisms or grisms, may be incorporated into the laser (at optional step 601) to shape either the gain spectrum or the spectral phase (to compensate for gain narrowing or dispersion, respectively), thereby producing a more nearly Fourier transform limited pulse.

A mode-locked semiconductor laser such as that disclosed by Gee et al. is based on integratable solid-state components and may replace lasers having separate components (e.g., mirrors, gain crystal, etc.) “connected” by use of free-space propagation of light. Therefore, the use of a mode-locked semiconductor laser in the method illustrated in FIG. 6 can produce significant advantages over conventional ultra-short pulse laser-based terahertz systems, which are typically quite large and consume a great deal of power. A mode-locked semiconductor laser and target can be produced in a more compact and portable form than conventional short-pulse laser systems. For example, in one embodiment, the components of the laser are integrated into a single-chip scale device. Thus, mode-locked semi-conductor lasers also typically consume less power than laser systems typically used for the generation of terahertz radiation. Furthermore, because a mode-locked semiconductor laser is a solid state source (as opposed to the vacuum-based electron sources such as those illustrated in FIGS. 2-5), it may offer advantages for a number of other applications including imaging, communications and spectroscopy.

Thus the present invention represents a significant advancement in the field of terahertz source technology. A terahertz radiation source is provided that substantially more compact and efficient than existing terahertz sources. Furthermore, in several embodiments, the invention may be tuned or configured to produce multiple wavelengths of radiation, both individually and simultaneously, thereby facilitating more accurate and efficient detection of contaminants in an analyzed target. The present invention may have further advantages in the fields of imaging, communications and spectroscopy.

While foregoing is directed to the preferred embodiment of the present invention, other and further embodiments of the invention may be devised without departing from the basic scope thereof, and the scope thereof is determined by the claims that follow.

1. Apparatus for producing terahertz radiation, comprising:
an electron beam source for emitting at least one electron beam; and
a variable-period corrugated grating positioned proximate to the electron beam source.

2. The apparatus of claim 1, wherein the variable-period corrugated grating comprises a single grating having a deformed period.

3. The apparatus of claim 2, wherein the variable-period corrugated grating is mounted on a rotatable surface.

4. The apparatus of claim 1, wherein the apparatus further comprises:
a yoke positioned between the at least one electron beam source and the variable period corrugated grating.

5. The apparatus of claim 4, wherein the variable-period corrugated grating comprises at least two sets of substantially uniform-period gratings, each set of substantially uniform-period gratings having a different period.

6. The apparatus of claim 5, wherein the yoke is positionable to selectively direct the at least one electron beam over any one of the at least two sets of substantially uniform-period gratings.

7. The apparatus of claim 1, wherein the variable-period corrugated grating is tapered from a first end of the grating to a second end.

8. The apparatus of claim 7, wherein the period of the variable-period corrugated grating at the first end is shorter than the period at the second end.

9. The apparatus of claim 1, wherein the electron beam source comprises an array of emitters positioned substantially coplanar with the variable-period corrugated grating for emitting a plurality of electron beams simultaneously.

10. The apparatus of claim 9, wherein each of the plurality of electron beams emitted by the array of emitters travels at substantially the same velocity.

11. The apparatus of claim 9, further comprising:
a lens positioned between the array of emitters and the variable-period corrugated grating.

12. The apparatus of claim 11, wherein the lens has varying optical properties over the surface of the lens for focusing the plurality of electron beams over the variable-period corrugated grating.

13. The apparatus of claim 11, wherein the lens is angled for focusing the plurality of electron beams over the variable-period corrugated grating.

14. A method for generating terahertz radiation, the method comprising the step of:
generating at least one electron beam; and
passing the least one electron beam over a variable-period corrugated grating.

15. The method of claim 14, wherein the step of passing the at least one electron beam over the variable-period corrugated grating further comprises:
rotating the variable period corrugated grating to present varying periods to at least one steady electron beam.

16. The method of claim 14, wherein the step of passing the at least one electron beam over the variable-period corrugated grating further comprises:
positioning a yoke between the at least one electron beam and the variable-period corrugated grating;
passing the at least one electron beam through the yoke; and
positioning the yoke to selectively direct the at least one electron beam over a section of the variable-period corrugated grating.

17. The method of claim 14, wherein the step of generating the at least one electron beam comprises generating a plurality of electron beams using an array of emitters.

18. The method of claim 17, further comprising the step of:
focusing the plurality of electron beams through a lens prior to passing the plurality of electron beams over the variable-period corrugated grating.

19. A method for generating terahertz radiation, the method comprising the steps of:
using a mode-locked semiconductor laser to emit at least one short optical pulse;
directing the at least one optical pulse to illuminate an absorbing target; and
rectifying the at least one optical pulse to produce a single-cycle terahertz pulse.

20. The method of claim 19, further comprising the step of:
incorporating compensation optics into the mode-locked semiconductor laser.

21. A method for generating terahertz radiation, the method comprising the steps of:
applying a photoconductive switch to an absorbing target;
using a mode-locked semiconductor laser to generate a photocurrent; and
illuminating the absorbing target using the generated photocurrent,
wherein a broadband, single cycle terahertz pulse is produced that is proportional to a time-derivative of the generated photocurrent.

22. The method of claim 21, wherein the absorbing target is a gallium arsenide or silicon substrate.
